(19) United States
(12) Patent Application Publication
(10) Pub. No.: US 2025/0203361 A1
(43) Pub. Date: Jun. 19, 2025

(54) SYSTEMS AND METHODS FOR MANAGING AUTHENTICATION OF WIRELESS DEVICES IN A WIRELESS NETWORK

(71) Applicant: T-Mobile Innovations LLC, Overland Park, KS (US)

(72) Inventors: Subramania KAUSHIK, Bellevue, WA (US); Anil Kumar MARIYANI, Ashburn, VA (US)

(21) Appl. No.: 18/545,345

(22) Filed: Dec. 19, 2023

(51) Int. Cl. H04W 12/06; H04W 12/72

(52) U.S. Cl. CPC H04W 12/06; H04W 12/72

(57) ABSTRACT

Systems and methods are provided for authenticating wireless devices in a wireless network. Methods include maintaining, by an authentication server, one or more mapping tables, wherein the one or more mapping tables map the one or more wireless devices to data management segments. The methods further include communicating, by the authentication server, directly with the data management segments indicated in the mapping tables corresponding to the one or more wireless devices to authenticate the one or more wireless devices.

### TECHNICAL BACKGROUND

As wireless networks evolve and grow, there are ongoing challenges in communicating data across such vast networks. Modern wireless networks contain millions of wireless devices spread across many thousands of access nodes and hundreds of data centers. With so many wireless devices, the amount of traffic required for the wireless network to function is extremely large. Any method that can reduce traffic for each wireless device can accumulate to be very impactful. Since each wireless device must authenticate to the wireless network, reducing authentication traffic could have enormous impacts on the wireless network as a whole.

### OVERVIEW

Examples described herein includes systems and methods of managing authentication of wireless devices in a wireless network, specifically for an efficient method of authenticating wireless devices in a manner that reduces network traffic and latency. An exemplary method includes maintaining, by an authentication server, one or more mapping tables, wherein the one or more mapping tables map the one or more wireless devices to data management segments. The method further includes communicating, by the authentication server, directly with the data management segments indicated in the mapping tables corresponding to the one or more wireless devices to authenticate the one or more wireless devices.

Another exemplary embodiment includes a system including one or more data segments and an authentication server including at least one electronic processor configured to perform operations. The operations include maintaining one or more mapping tables, wherein the one or more mapping tables map the one or more wireless devices to the one or more data management segments. The operations further include, communicating directly with the data management segments indicated in the one or more mapping tables corresponding to the one or more wireless devices to authenticate the one or more wireless devices.

Another exemplary embodiment includes a method of authenticating one or more wireless devices. The method includes maintaining by an Authentication Server Function (AUSF), one or more mapping tables, wherein the one or more mapping tables map the one or more wireless devices to data management segments. The method further includes communicating, without requiring a Service Communication Proxy or a Subscriber Locate Function, with the data management segments indicated in the one or more mapping tables corresponding to the one or more wireless devices to authenticate the one or more wireless devices.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for authentication in a wireless network in accordance with various aspects of the present disclosure;

FIG. 2 illustrates an exemplary processing node in accordance with various aspects of the present disclosure;

FIG. 3 illustrates an exemplary process flow for managing authentication in a wireless network; and

FIG. 4 illustrates an exemplary process flow for managing authentication in a wireless network.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a cellular or wireless network may be provided by a wireless provider. The wireless network includes many parts performing many functions. Some examples of these network functions include a Network Repository Function (NRF), an Access and Mobility Management Function (AMF), a Subscriber Locate Function (SLF), a Service Communication Proxy (SCP) and an Authentication Server Function (AUSF). The NFs may form a micro services-based architecture, which may include network functions distributed over different cloud infrastructures. Additionally, many services may span different network functions and domains that work in unison. A wireless provider would typically provide service to millions of wireless devices spread across a vast geographic area. To adequately provide wireless service, it is necessary for the various parts of the wireless network be duplicated and dispersed geographically. Sometimes, this dispersal can cause significant latency in communication.

The NRF maintains the list of available network functions and their profiles. The NRF maintains an updated repository of the network components along with services provided by each of the elements in the core network. The NRF additionally provides a discovery mechanism that allows the elements to discover each other. The NRF provides a registration function that allows each network function to register a profile and a list of services with the NRF. It also performs services registration and discovery so that different network functions can find each other. The NRF broadcasts available services once they are registered in the network. To use other network functions, registered functions can send service requests to the NRF.

The UDM interfaces with NFs such as AMF so that relevant data becomes available to AMF. The UDM generates authentication vectors when requested by the AUSF, which acts as an authentication server. The UDR may provide unified data storage accessible to both control plane NFs and user plane NFs. The UDR may include information about subscribers, application-specific data, and policy data. The UDR can store structured data that can be exposed to an NF.

One of the necessary back-end services provides authentication for the wireless devices. This authentication service ensures that only authorized wireless devices gain access to the wireless network as well as ensuring the wireless devices gain access to only the services authorized for the owner of that wireless device. The authentication process itself has many steps and requires the use of many components of the provider's network. Typically, a wireless device will connect to an access node seeking service. The access node then communicates with the Authentication Server Function (AUSF). The AUSF must eventually communicate with the Unified Data Management (UDM) for the authentication to take place. This communication is known as the N13 interface. The AUSF sends a request to the Network Repository Function (NRF) asking which Subscriber Locate Function (SLF) it should use to locate the subscription data and other records for the wireless device. The AUSF then queries the SLF via the Service Communication Proxy (SCP) for the data on the wireless device. The SLF then queries the UDM for the authentication information which then queries the Unified Data Repository (UDR) and performs the actual authentication of the wireless device.

Typically, these various functions are geographically dispersed which can lead to unnecessary network traffic and therefore latency slowing down the whole process. The AUSF is usually collocated with the UDM/UDR, but the other components may not be, introducing significant inefficiency into the system. For example, the AUSF, UDM and UDR may be located in Dallas, but the SCP may be in Chicago. The AUSF needs the information and authentication process from the UDM/UDR in Dallas but must make queries to a service in Chicago in order to perform the authentication. This requires traffic to travel from Dallas to Chicago and back multiple times for the AUSF to work with the locally located UDM/UDR to authenticate a wireless device. These multiple trips waste significant network resources and introduce significant latency to the authentication process.

There are many advantages to be had by centralizing to a single AUSF instance deployed to a common application cloud and separating out multiple UDM/UDR instances. While a single AUSF instance is discussed, it should be understood that the AUSF instance will be configured for fault tolerance and may consist of multiple redundant instances performing as one or in standby for the primary AUSF instance. Likewise, while a single UDM instance and UDR instance per data management segment is discussed, each instance may be configured for fault tolerance and may actually consist of multiple redundant instances working together as one or in standby for their respective primary instance. A single AUSF may be more secure since it is separate from other services and may be better locked down to allow only the necessary incoming and outgoing traffic required for the authentication service. The multiple data management segments, each containing a UDM and UDR, can each be configured in different ways, including separating them out by customer, service type and/or rate plan, for example. Pairing the UDM and UDR in this manner allows the frequent traffic between them to stay local to the data management segment they are in, thus reducing network traffic and latency. A single AUSF and multiple data management segments allows for more flexibility in network design and allows moving the authentication elements closer to the network services that use them to further reduce network traffic and latency.

To allow this architecture and to further improve the traffic and latency reductions, a new method of managing the authentication process is proposed. In this new method, the AUSF maintains one or more mapping tables which map wireless devices to assigned data management segments. The wireless device may be identified by Subscription Permanent Identifiers (SUPI) or Subscription Concealed Identifiers (SUCI) such as International Mobile Subscriber Identity (IMSI) or Network Access Identifier (NAI) and may be mapped to specific data management segments by ranges of these globally unique identifiers. An example of a typical mapping table is shown in Table 1 below.

TABLE 1

| UDR/UDM Segment | Identifier Range |
|---|---|
| Segment-1 | 310260000000000-310260999999999 |
| Segment-2 | 310240000000000-310240999999999 |
| Segment-3 | 310120000000000-310120999999999 |
| Segment-4 | 312530000000000-312530999999999 |
| Segment-5 | 311882000000000-311882999999999 |
| Segment-n | 310250000000000-310250999999999 |

With a mapping table such as that shown above in Table 1 maintained at the AUSF, the N13 communications may take place directly between the AUSF and UDM/UDR, without the need of the interim steps with the NRF, SLF and SCP. This will decrease the network traffic requirements and network latency for each wireless device authentication. Cumulatively, over the millions of wireless devices served by a typical wireless service provider, the improvements are significant.

Another improvement this method allows is the direct and dynamic maintenance of the mapping table at the AUSF. Previously, the information used in the authentication process was maintained across the NRF, SLF and SCP. Any updates to this information such as adding, modifying, or deleting ranges, could take significant time to propagate and may even require the restart of some of these services. With the proposed method, the AUSF dynamically maintains the mapping tables directly meaning changes are easy and take immediate effect. The AUSF has the capability to add/modify/delete SUPI ranges dynamically without any process or application restarts.

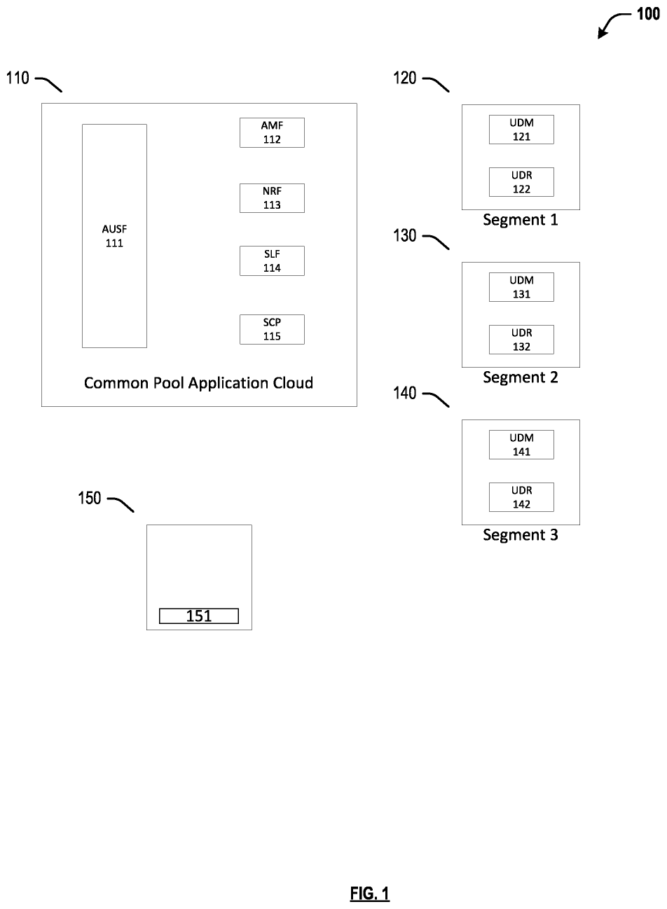

FIG. 1 depicts an exemplary system 100 for managing authentication of wireless devices in a wireless network. System 100 includes a Common Pool Application Cloud 110 which is a way of logically grouping the various servers and functions necessary to manage a large wireless network. The Common Pool Application Cloud 110 may include the Authentication Server Function (AUSF) 111, Access and Mobility Management Function (AMF) 112, Network Repository Function (NRF) 113, Subscriber Locate Function (SLF) 114 and Service Communication Proxy (SCP) 115. The system 100 may also include multiple data management segments 120, 130 and 140. Three data management segments are shown, but any number may be used. Each data management segment includes a Unified Data Management (UDM) 121/131/141 and a Unified Data Repository (UDR) 122/132/142. The system 100 also includes one or more wireless devices, one of which is represented at 150. Each wireless device 150 may be identified by a unique identifier 151. The unique identifier may be globally unique and may be an IMSI or a Network Access Identifier (NAI), for example.

Wireless device 150 may be any device, system, combination of devices, or other such communication platform capable of communicating on the wireless network using one or more frequency bands deployed therefrom. Each wireless device 150 may be, for example, a mobile phone, a wireless phone, a wireless modem, a personal digital assistant (PDA), a voice over internet protocol (VOIP) phone, a voice over packet (VOP) phone, or a soft phone, as well as other types of devices or systems that can exchange audio or data via the wireless network. Other types of communication platforms are possible.

In operation, the system 100 may be configured such that an authentication server, such as AUSF 111, maintains one or more mapping tables, wherein the one or more mapping tables map the one or more wireless devices, such as wireless device 150, to data management segments, such as data management segments 120, 130 and 140. The authentication server may then communicate directly with the data management segments indicated in the mapping tables corresponding to the one or more wireless devices to authenticate the one or more wireless devices.

Other network elements may be present in system 100 to facilitate communication but are omitted for clarity, such as access nodes, base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements.

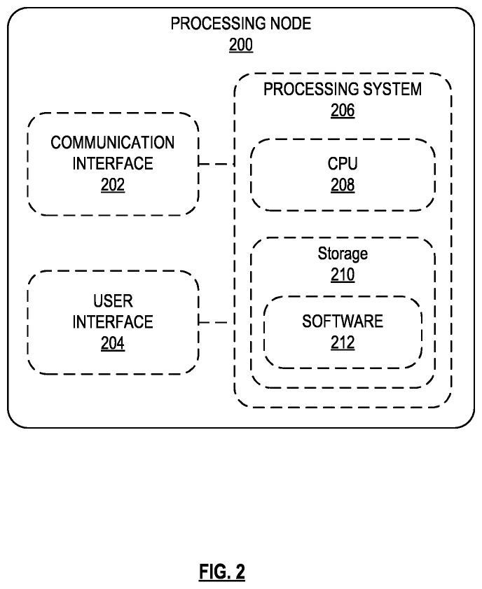

FIG. 2 depicts an exemplary processing node 200 for managing authentication of wireless devices in a wireless network. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a microprocessor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200. Processing node 200 may be a part of an authentication server such as the AUSF 111.

In an exemplary embodiment, software 212 can include instructions for maintaining one or more mapping tables, wherein the one or more mapping tables map one or more wireless devices to data management segments, such as those represented at 120, 130 and 140. The instructions further include communicating directly with the data management segments indicated in the one or more mapping tables corresponding to the one or more wireless devices to authenticate the wireless devices. The software 212 may optionally include instructions for updating the one or more mapping tables at the authentication server.

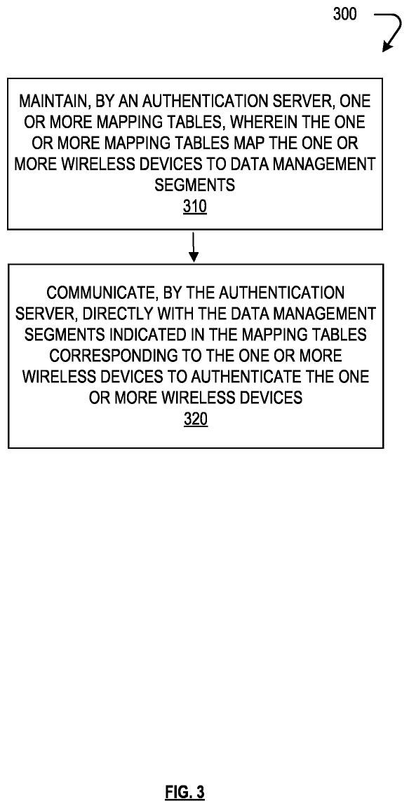

FIG. 3 illustrates an exemplary method 300 for managing authentication of wireless devices in a wireless network. Method 300 may be performed by any suitable combination of processors, for example processing node 200. Although FIG. 3 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 300 begins in step 310 where one or more mapping tables are maintained by an authentication server. The one or more mapping tables being configured to map the one or more wireless devices to data management segments. Method 300 continues in step 320 where the authentication server communicates directly with the data management segments indicated in the mapping tables corresponding to the one or more wireless devices in order to authenticate the one or more wireless devices. The wireless device may be represented in the mapping tables by way of a unique identifier, such as an IMSI or NAI. The mapping tables may map a range of these identifiers to a data management segment. The data management segments may each include a UDM and UDR and the UDM and UDR may be physically located in the same data center or even the same physical hardware. Collocated UDMs and UDRs allow the necessary traffic to flow between these elements directly without leaving the data management segments. Method 300 may include the optional step of updating the one or more mapping tables. Since the mapping tables are maintained by the authentication server, they may be updated with new or modified information dynamically and in real time.

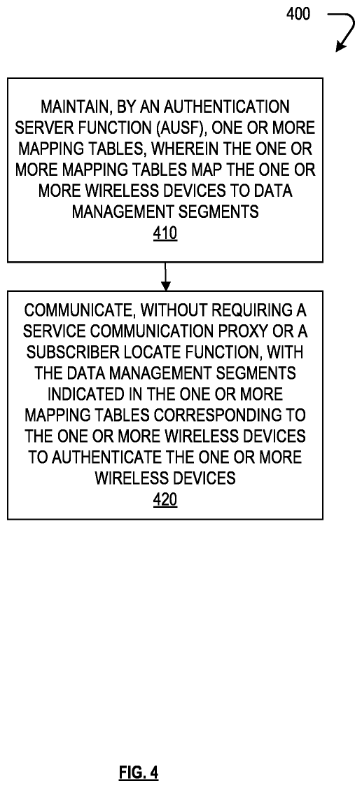

FIG. 4 illustrates an exemplary method 400 for managing authentication of wireless devices in a wireless network. Method 400 may be performed by any suitable combination of processors, for example processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where one or more mapping tables are maintained by an AUSF. The one or more mapping tables being configured to map the one or more wireless devices to data management segments. Method 400 continues in step 420 where the AUSF communicates directly, without requiring an SCP or SLF, with the data management segments indicated in the mapping tables corresponding to the one or more wireless devices in order to authenticate the one or more wireless devices. AUSF has the capability to add/modify/delete SUPI ranges dynamically without any process or application restarts. The wireless device may be represented in the mapping tables by way of a unique identifier, such as an IMSI or NAI, for example. The mapping tables may map a range of these identifiers to a data management segment. The data management segments may each include a UDM and UDR and the UDM and UDR may be physically located in the same data center or even the same physical hardware. Collocated UDMs and UDRs allow the necessary traffic to flow between these elements directly without leaving the data management segments. Method 300 may include the optional step of updating the one or more mapping tables. Since the mapping tables are maintained by the AUSF, they may be updated with new or modified information dynamically and in real time.

In some embodiments, methods 300 and 400 may include additional steps or operations. Furthermore, the methods may include steps shown in each of the other methods. As one of ordinary skill in the art would understand, the methods of 300 and 400 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of authenticating one or more wireless devices, the method comprising:
maintaining, by an authentication server, one or more mapping tables, wherein the one or more mapping tables map the one or more wireless devices to data management segments; and
communicating, by the authentication server, directly with the data management segments indicated in the mapping tables corresponding to the one or more wireless devices to authenticate the one or more wireless devices.

2. The method of claim 1, wherein the one or more wireless devices are identified by a globally unique identifier and the one or more mapping tables map one or more ranges of globally unique identifiers to one of the data management segments.

3. The method of claim 2, wherein the globally unique identifiers are International Mobile Subscriber Identities (IMSI).

4. The method of claim 2, wherein the globally unique identifiers are Network Access Identifiers.

5. The method of claim 1, the method further comprising:
updating, at the authentication server, the one or more mapping tables.

6. The method of claim 1, wherein the data management segments comprise: a Unified Data Management (UDM) server and a Unified Data Repository (UDR).

7. The method of claim 6, wherein the UDM and UDR are collocated, allowing traffic between the UDM and UDR to be direct, without leaving a data management segment.

8. A system comprising:
one or more data management segments; and
an authentication server including at least one electronic processor configured to perform operations including:
maintaining one or more mapping tables, wherein the one or more mapping tables map one or more wireless devices to the one or more data management segments; and
communicating directly with the one or more data management segments indicated in the one or more mapping tables corresponding to the one or more wireless devices to authenticate the one or more wireless devices.

9. The system of claim 8, wherein the one or more wireless devices are identified by a globally unique identifier and the one or more mapping tables map one or more ranges of globally unique identifiers to one of the data management segments.

10. The system of claim 9, wherein the globally unique identifiers are International Mobile Subscriber Identities (IMSI).

11. The system of claim 9, wherein the globally unique identifiers are Network Access Identifiers.

12. The system of claim 8, the operations further comprising:
updating, at the authentication server, the one or more mapping tables.

13. The system of claim 8, wherein the one or more data management segments comprise: a Unified Data Management (UDM) server and a Unified Data Repository (UDR).

14. The system of claim 13, wherein the UDM and UDR are collocated, allowing traffic between the UDM and UDR to be direct, without leaving the data management segment.

15. A method of authenticating one or more wireless devices, the method comprising:
maintaining, by an Authentication Server Function (AUSF), one or more mapping tables, wherein the one or more mapping tables map the one or more wireless devices to data management segment; and
communicating, by the AUSF, without requiring a Service Communication Proxy or a Subscriber Locate Function, with the data management segments indicated in the one or more mapping tables corresponding to the one or more wireless devices to authenticate the one or more wireless devices.

16. The method of claim 15, wherein the one or more wireless devices are identified by a globally unique identifier and the one or more mapping tables map one or more ranges of globally unique identifiers to one of the data management segments.

17. The method of claim 16, wherein the globally unique identifiers are International Mobile Subscriber Identities (IMSI).

18. The method of claim 16, wherein the globally unique identifiers are Network Access Identifiers.

19. The method of claim 15, the method further comprising:
updating, at the AUSF, the one or more mapping tables.

20. The method of claim 15, wherein the one or more data management segments comprise: a Unified Data Management (UDM) server and a Unified Data Repository (UDR).
